(19) United States
(12) Patent Application Publication
(10) Pub. No.: US 2004/0133458 A1
(43) Pub. Date: Jul. 8, 2004

(54) Distribution scheduling system and method

(75) Inventor: Michael Shane Hanrahan, Neunkirchen (DE)

Correspondence Address: KENYON & KENYON, 1500 K STREET, N.W., SUITE 700, WASHINGTON, DC, 20005, US

(73) Assignee: SAP Aktiengesellschaft

(21) Appl. No.: 10/740,553

(22) Filed: Dec. 22, 2003

Related U.S. Application Data
(60) Provisional application No. 60/435,279, filed on Dec. 23, 2002.
(60) Provisional application No. 60/435,280, filed on Dec. 23, 2002.
(60) Provisional application No. 60/435,351, filed on Dec. 23, 2002.
(60) Provisional application No. 60/435,352, filed on Dec. 23, 2002.

(51) Int. Cl. G06F 17/60

(52) U.S. Cl. 705/8

(57) ABSTRACT

A method and system for creating a distribution schedule is provided. At least one demand object may be selected from a plurality of available demand objects, at least one supply object may be selected from a plurality of available supply objects, and at least one transportation object may be selected from a plurality of available transportation objects. The selected supply objects, the selected demand objects and the selected transportation objects may be pegged to create a voyage having an associated distribution schedule object.

### PRIORITY CLAIM/RELATED APPLICATION(S)

This patent application claims the benefit of four (4) U.S. Provisional Patent Applications: (1) Serial No. 60/435,279, filed Dec. 23, 2002; (2) Serial No. 60/435,280, filed Dec. 23, 2002; (3) Serial No. 60/435,351, filed Dec. 23, 2002; and (4) Serial No. 60/435,352, filed Dec. 23, 2002. These provisional patent applications are incorporated by reference herein in their entirety.

### TECHNICAL FIELD

The present invention relates to scheduling. More particularly, the present invention relates to a method and system for creating a distribution schedule.

### BACKGROUND OF THE INVENTION

The sale and distribution of any bulk material requires coordination between various participants, including buyers, sellers, transporters, etc. For example, distribution scheduling practice within the oil industry typically involves several participants and many steps. Traders make deals with buyers and sellers which result in purchase contracts and sales contracts, respectively. Freight contracts may also be in place between transporters, buyers and sellers. These various contracts may be captured on paper at a minimum, and, at best, memorialized within a computer-based contracts system. Additionally, purchase and sales contracts may be summarized in purchase and sales listings, respectively, identifying the essentials of each contract, such as partner name, location(s), material, quantities, dates, etc. Schedulers use these purchase and sales listings, combined with their own knowledge of potentially available transportation facilities, to attempt to build nominations, also known as voyages, directly on a one-by-one basis. The schedule of nominations is typically built using a simple spreadsheet program, such as Microsoft® Excel®, for example.

It is not unusual practice for the scheduler to manually enter the schedule of nominations into a second computer system, such as a mainframe, legacy system, messaging system, etc., for communication to all the relevant participants. Unfortunately, even though freight contacts may already be in place between the transporter, buyer and seller, the scheduler typically does not have access to electronic freight contract data, and, consequently, may need to manually enter freight information into the schedule of nominations based on his own personal knowledge or, if available, hardcopy printouts of freight contacts. Furthermore, the scheduler usually does not have an overview of the usage of the sales, purchase or freight contracts to date, other than information reflected by his own personal records. While participants may provide updated usage information related to sales, purchase or freight contracts, the scheduler typically reflects these updates only within the schedule of nominations at best, and not, for example, within the second computer system.

### SUMMARY OF THE INVENTION

Embodiments of the present invention provide a method and system for creating a distribution schedule. At least one demand object may be selected from a plurality of available demand objects, at least one supply object may be selected from a plurality of available supply objects, and at least one transportation object may be selected from a plurality of available transportation objects. The selected supply objects, the selected demand objects and the selected transportation objects may be pegged to create a voyage having an associated distribution schedule object.

### BRIEF DESCRIPTION OF THE DRAWINGS

FIG. 1 is a system diagram of a distribution scheduling system, according to an embodiment of the present invention.

FIG. 2 is a detailed diagram illustrating a business object and associated business object interface, according to an embodiment of the present invention.

FIG. 3 is a detailed diagram illustrating a data selection interface, according to an embodiment of the present invention.

FIG. 4 is a detailed diagram illustrating a variant selection interface, according to an embodiment of the present invention.

FIGS. 5-8 are detailed diagrams illustrating an distribution scheduling interface, according to an embodiment of the present invention.

FIG. 9 is a top level flow diagram illustrating a method for creating a distribution schedule, according to an embodiment of the present invention.

### DETAILED DESCRIPTION

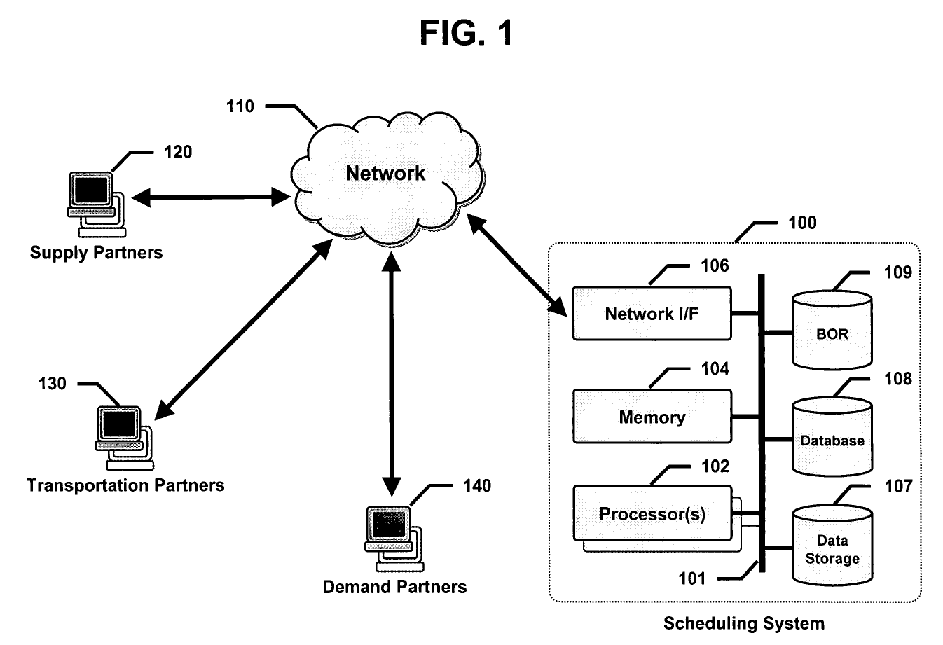

FIG. 1 is a diagram of a distribution scheduling system, according to an embodiment of the present invention. Scheduling system 100 may be coupled to network 110, which, in turn, may be coupled to several different partners, such as, for example, supply partners 120, transportation partners 130 and demand partners 140. Scheduling system 100 may present a graphical user interface to a scheduler to facilitate data entry, schedule creation, nomination communication, etc.

Network 110 may be any type of communications network, including, for example, a local area network (LAN), a wide area network (WAN), the Internet, the public switched telephone network (PSTN), a national or international telecommunications network, or any combination of wired or wireless communications networks. These networks and combinations of networks include intermediate destination points, e.g. switches, routers, gateways, etc., that receive and retransmit the information across the network. Network 110 may be, for example, a data communications network using Internet Protocol (IP), Transmission Control Protocol/Internet Protocol (TCP/IP), and/or HyperText Transfer Protocol (HTTP), a telecommunications network using Integrated Services Digital Network (ISDN) protocol, a wireless telecommunications network using Wireless Application Protocol (WAP), etc.

Data communications between scheduling system 100 and supply partners 120, transportation partners 130 and demand partners 140 may be bidirectional, i.e., information may be transmitted to, as well as received from, these partners over network 110. Various well-known authentication and data encryption techniques may be used to preserve an appropriate level of security in the public network context, including, for example, HTTPS (HyperText Transfer Protocol with Secure Sockets Layer), etc. These partners may communicate with scheduling system 100 though network 110 using network-enabled personal communication devices, such as, for example, desktop, notebook or laptop computers, pocket computers, personal digital assistants or PDAs, smart cellular phones, etc. These devices may also include a network interface to connect to network 110, such as, for example, a coaxial cable interface, a fiber-optic interface, a wireless network interface, etc.

Scheduling system 100 may include processor 102, memory 104, network interface (I/F) 106, general data storage 107, database 108 and, in an object oriented embodiment, business object repository (BOR) 109, interconnected through general system bus 101. Processor 102 may be a general purpose microprocessor, such as the Pentium V microprocessor manufactured by the Intel Corporation of Santa Clara, Calif., or an Application Specific Integrated Circuit (“ASIC”) that embodies at least a part of the method, in accordance with embodiments of the present invention, in its hardware and/or firmware. Scheduling system 100 may also include multiple processors 102, as shown in phantom outline in FIG. 1.

Memory 104 may be any memory device adapted to store electronic information, such as, for example, data and instructions adapted to be executed by processor 102, including Random Access Memory (RAM), etc., while general data storage 107, database 108 and BOR 109 may be non-volatile, mass storage devices, such as, for example, hard disks, CD-ROM R/W, DVD-R, etc. In one embodiment, general data storage 107, database 108 and BOR 109 may be separate physical devices, while in another embodiment, general data storage 107, database 108 and BOR 109, may be accommodated within one, or more, physical devices.

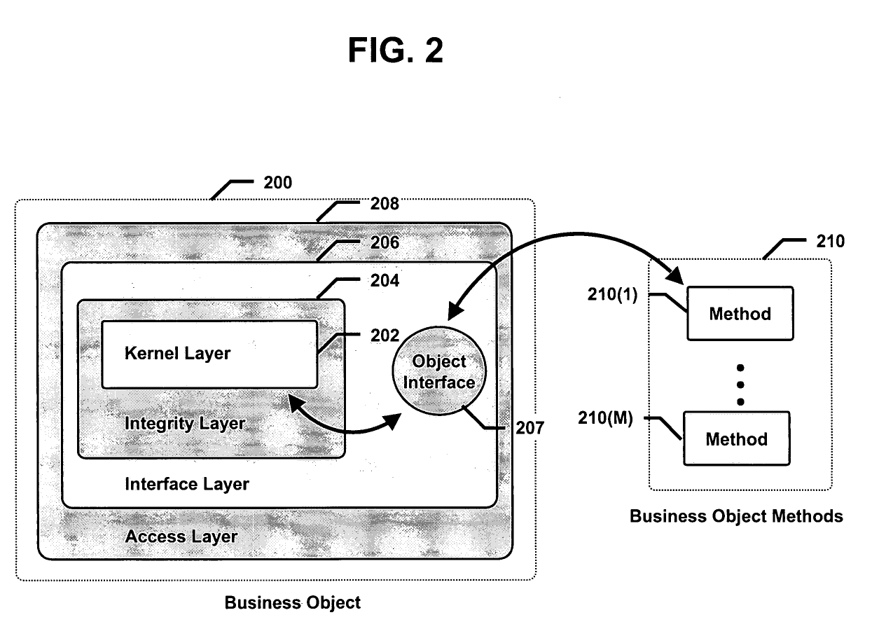

FIG. 2 is a detailed diagram illustrating a business object, according to an embodiment of the present invention.

Scheduling system 100 may include software components expressing the functionality and dependencies of various business processes and data, typically architected according to well-known object-oriented programming (OOP) methods and constructs. Generally, these software components may include application programs and databases, interface libraries, etc., developed, in many cases, using object-oriented software development tools, such as, for example, SAP Software Development Kit (SDK Version 6.2, manufactured by SAP AG of Walldorf, Germany), etc.

In an embodiment, scheduling system 100 may include a plurality of business objects which encapsulate various business methods and data, while hiding structure and implementation details from higher-level software components, such as, for example, business applications. Generally, business objects may include data definitions, methods, operational rules and constraints, access specifications, etc., that are particular to a specific business component, process, logical construct, etc. Various interfaces may be defined to provide access to the methods and data associated with a particular business object, such as, for example, business application programming interfaces, or “BAPIs”.

Each business object may be created as an instance of a business object type. For example, each employee of a company may be represented by an instance of an Employee business object type. Business object types may be stored within a business object repository, such as, for example, BOR 109, etc., while business objects (also known as business object instances, object instances, objects, etc.) may be stored within a different database, such as, for example, database 108, etc. In an embodiment, business object 200 may include kernel layer 202, integrity layer 204, interface layer 206 and access layer 208.

Kernel layer 202 may include data inherently associated with business object 200. For example, an employee business object may include data representing an employee identification number, name, supervisor, business division, etc. Integrity layer 204 may include rules and constraints associated with the environment. Interface layer 206 may describe the implementation and structure of the various methods associated with business object 200, and may include one or more associated interfaces, such as, for example, business object interface 207. Access layer 208 may define various technologies that may be used to access business object 200, such as, for example, COM/DCOM (component object model/distributed component object model), RFC (remote function call), JAVA, CORBA (common object request broker architecture), etc.

In an embodiment, plurality of business object methods 210, i.e., business object method 210(1). . . 210(M), etc., may also provide access to, or operate upon, data defined within kernel layer 202 of business object 200. In this embodiment, plurality of business object methods 210 may be constructed as function modules compatible with the Remote Function Call (RFC) protocol. Each function module may also be associated with a corresponding business object interface, such as, for example, business object interface 207. Plurality of business object methods 210 may be stored within a business object repository, such as, for example, BOR 109, or, alternatively, plurality of business object methods 210 may be stored within a remote network database.

In an embodiment, scheduling system 100 may plan the distribution schedule of bulk oil or gas product using nominations. Various information may be stored within data storage 107 or database 108, such as, for example, material supply and demand quantities, locations and dates, transportation system capabilities and availabilities, scheduling and nomination information, etc. Additionally, information describing supply partners 120, transportation partners 130 and demand partners 140 may also be stored within data storage 107 or database 108. Information may be entered into scheduling system 100 manually, using one or more data input interfaces, or created by one or more processes executing on processor 102. In one embodiment, information associated with various oil or gas contracts, such as, for example, sales contracts, purchase contracts, freight contracts, etc., may be entered into scheduling system 100 to form the basic data set from which the distribution schedule may be created. In another embodiment, sales contract information, purchase contract information, freight contract information, etc., may be imported into scheduling system 100, via network 110, from one, or more, other systems, such as, for example, a trading deal capture system. Various processes may execute on processor 102 to plan the distribution schedule of bulk oil or gas product, such as, for example, high-level applications, low-level functions, remote function calls, etc.

In an embodiment, these data may be represented by various data structures, such as, for example, a supply item data structure, a demand item data structure, a transportation item data structure, a distribution schedule data structure, etc., and stored, generally, within data storage 107. In another embodiment, these data may be represented by various database tables and stored within database 108, such as, for example, a supply item table, a demand item table, a transportation item table, a distribution schedule table, etc. In a further embodiment, these data may be represented by various classes and stored within data storage 107, or database 108, as instances of these classes, such as, for example, a supply item class, a demand item class, a transportation item class, a distribution schedule class, etc.

In yet another embodiment, these data may be represented by several different types of business objects, such as, for example, supply objects, demand objects, transportation objects, distribution schedule objects, etc., each defined by their corresponding business object type. Business object types may be stored within BOR 109, for example, while business object instances, or, more simply, business objects or objects, may be stored within database 108.

A supply object may include information associated with a particular quantity of oil or gas provided by a supply partner, such as, for example, a supply partner identifier, location identifier, material type, quantity, available dates, sales contract references, etc. Similarly, a demand object may include information associated with a particular quantity of oil or gas required by a demand partner, such as, for example, a demand partner identifier, location identifier, material type, quantity, available dates, purchase contract references, etc. A transportation object may include information associated with a particular transportation medium (e.g., marine vessel, train, pipeline, etc.) provided by a transportation partner, such as, for example, a vehicle identifier, owner identifier, location identifier(s), material type(s), capacity, available dates, freight contract references, etc. A distribution schedule object may include schedule information, such as, for example, a nomination identifier, vehicle identifier, scheduled quantity, supply partner identifier, demand partner identifier, transport partner identifier, nomination dates, geographic location data, etc.

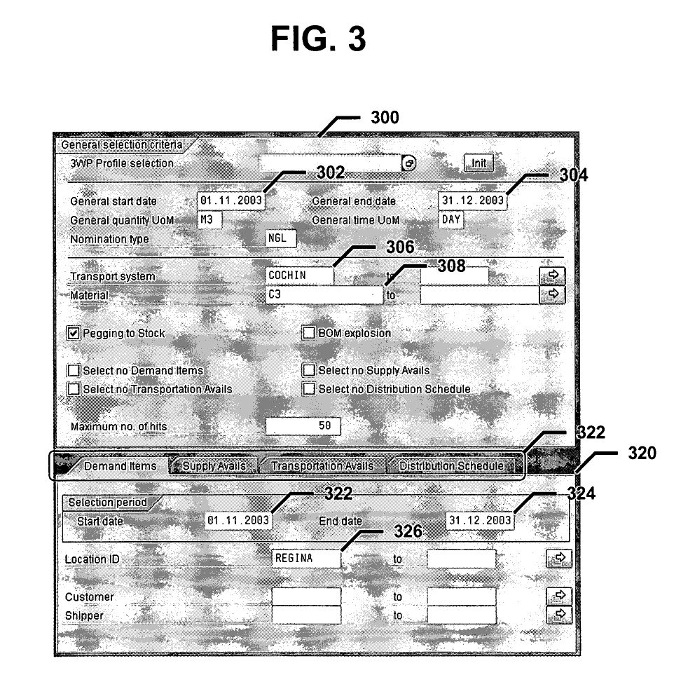

FIG. 3 is a detailed diagram illustrating a data selection interface, according to an embodiment of the present invention.

Generally, sales, purchase and freight information, initially entered into scheduling system 100, may form a data set from which a distribution schedule may be created. In an embodiment, these data may be stored within database 108 as business objects, as described above. Accordingly, database 108 may contain supply objects, demand objects and transportation objects, as well as other types of objects or data. In one embodiment, the creation of a particular distribution schedule may begin with the identification of available resources. For example, distribution schedules are typically planned for a particular period of time bounded by a start date and an end date. Supply objects, demand objects and transportation objects, stored within database 108, may be identified as available objects, in part, based on temporal availability information stored within each object, i.e., the start date and end date during which time the resource is available. Other criteria, such as material type, geographic location, etc., may also be included in the identification of available resources.

For example, supply object start and end dates may represent the period of time during which oil or gas product is available for transportation from a particular location. Similarly, demand object start and end dates may represent the period of time during which oil or gas product is desired to be delivered to a particular location. Supply and demand objects may represent production facilities, storage facilities, refineries, etc. Transportation object start and end dates may represent the period of time during which the transportation resource is available for use. For example, a transportation object representing a train may include start and end dates defining the period of time during which the train is available for use, as well as location information describing the geographic extent of the train services (i.e., the rail line). Of course, marine vessels offer different geographic availability than trains, trains offer different geographic availability than pipelines, etc.

In an embodiment, general selection window 300 and tabbed selection window 320 may be presented to a scheduler to select available resources. General selection window 300 may include various selection criteria, such as, for example, general start date 302, general end date 304, transport system 306 and material 308. Tabbed selection window 320 may include several tabs 322 to select individual demand, supply, transportation and distribution schedule selection windows. The demand selection window, depicted in FIG. 3, may include demand start date 322, demand end date 324, location identifier 326, as well as other selection information.

The supply selection window (not shown for clarity) may include similar data, such as supply start and end dates, location identifier, as well as other selection information. The transportation selection window (also not shown for clarity) may include transportation start and end dates, location identifier, transportation mode, transportation carrier, shipper, vehicle reference, as well as other selection information (e.g., minimum availability, nomination relevance period, remaining capacity, etc.). The distribution schedule selection window (also not shown for clarity) may include various criteria controlling the creation, scope, etc., of the distribution schedule, such as schedule start and end dates, location identifier, vehicle identifier, nomination identifier, shipper, vendor, etc.

The scheduler may enter general selection criteria within general selection window 300, and then enter resource-specific information within tabbed selection window 320 by sequentially selecting tabs 322, labeled “Demand Items,” as “Supply Avails,” “Transportation Avails” and “Distribution Schedule,” respectively, and then entering the appropriate demand, supply, transportation and distribution schedule information, as desired.

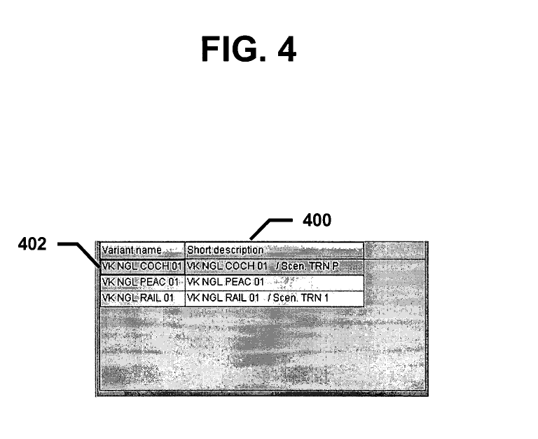

FIG. 4 is a detailed diagram illustrating a variant selection interface, according to an embodiment of the present invention.

In an embodiment, the scheduler may be presented with variant selection window 400 to facilitate the selection of available resources. In this embodiment, general, demand, supply, transportation and distribution schedule selection information may be stored within database 108 as a variant. Selection of variant 402, for example, will automatically populate general selection window 320 and each tabbed resource selection window 320.

Using the selection information, scheduling system 100 then searches database 108 to determine available resources, such as, for example, available supply objects, available demand objects, available transportation objects, etc. As noted above, search constraints may include dates, locations, material types, etc. The search may be instantiated, for example, in response to a command selected by the scheduler. In one embodiment, a distribution scheduling interface may then be presented to the scheduler.

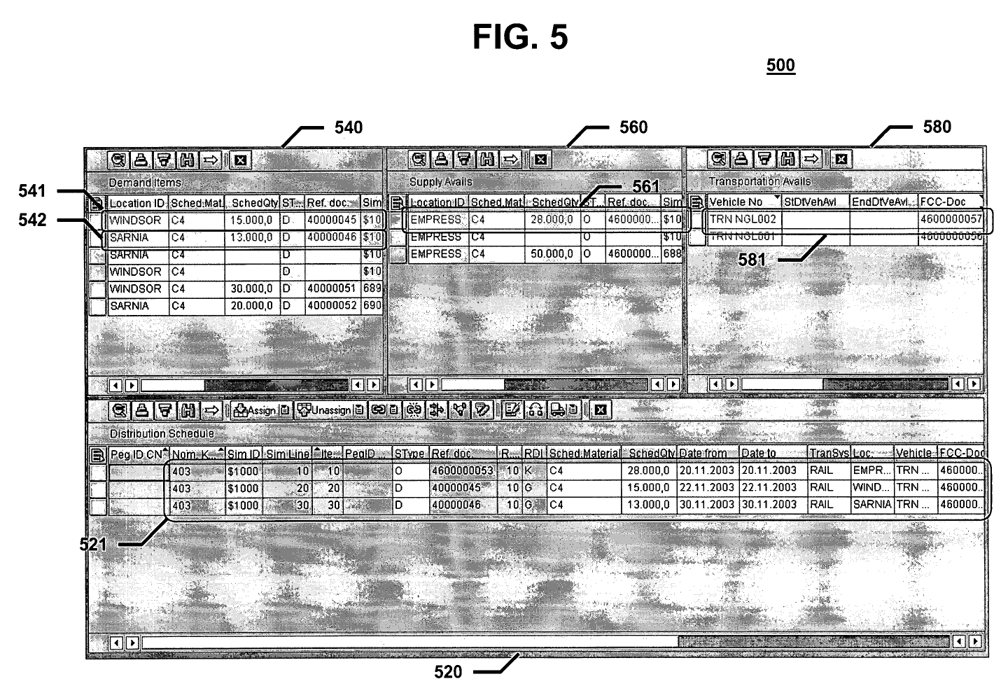

FIGS. 5-8 are detailed diagrams illustrating a distribution scheduling interface, according to an embodiment of the present invention.

Referring to FIG. 5, in an embodiment, distribution scheduling interface 500 may include, for example, distribution schedule window 520, demand window 540, supply window 560 and transportation window 580, as well as other windows or interface elements not shown for clarity. In one embodiment, available demand objects may be presented within demand window 540, and a subset of each available demand object's data may be displayed therein, such as, for example, a location identifier, a material type, a scheduled quantity, a reference document identifier (e.g., a purchase contract identifier), etc. Similarly, available supply objects may be presented within supply window 560, and a subset of each available supply object's data may be displayed therein, such as, for example, a location identifier, a material type, a quantity, a reference document identifier (e.g., a sales contract identifier), etc.

Both contract and stock positions may be represented by demand and supply objects. For example, a sales contract may specify that a particular quantity (e.g., 28,000 barrels) of light crude (e.g., material type C4) may be available at a specific location (e.g., EMPRESS), as represented by supply avail 561. Similarly, one or more purchase contracts may specify that a quantity of light crude may be required at one or more specific locations. For example, demand item 541 may specify that 15,000 barrels of material type C4 is required to be provided at WINDSOR, while demand item 542 may specify 13,000 barrels of material type C4 is required to be provided at SARINA. Stock positions may also be represented as well. For example, a supply object may define a particular quantity of available material stored in a tank farm, a demand object may define a particular quantity of material desired to be added to a tank farm, etc.

In one embodiment, available transportation objects may be presented within transportation window 580, and a subset of each available transportation object's data may be displayed therein, such as, for example, a vehicle number, vehicle availability start and end dates, a reference document identifier (e.g., a freight contract identifier), etc. For example, transportation avail 581 may specify that train “TRN NGL002” may be available under freight contract identifier “4600000057” and has the capacity to transport a specific quantity of material (assumed to be greater than the total demand items and supply avails for the purposes of illustration only; real trains are, of course, capacity-limited and would be constrained accordingly). In this example, supply avail 561, demand item 541 and demand item 542 are geographically-linked to a transportation system upon which transportation avail 581 may operate.

In one embodiment, distribution schedule window 520 may display information describing voyages associated with the available demand, supply and transportation objects. Accordingly, a schedule object may include information identifying the demand, supply and transportation objects forming the voyage, as well as other information (e.g., nomination information, etc.). For example, voyage 521 may include supply avail 561, demand item 541, demand item 542 and transportation avail 581. Supply avail 561, demand item 541 and demand item 542 may be represented by rows within voyage 521, while transportation avail 581 may be identified by one or more columns, such as, for example, “Vehicle” and “FCC-Doc” columns (i.e., vehicle identifier and freight contract document identifier columns, respectively). Nomination key “403” may refer to a nomination object created after the voyage has been scheduled. In this example, a single available transportation object was used for voyage 521; however, a portion of the transportation object's capabilities, or multiple transportation objects, may also be used. The construction of a voyage to distribute 30,000 barrels of C4 material from the EMPRESS location to the WINDSOR location using TRN 001 is described in more detail below.

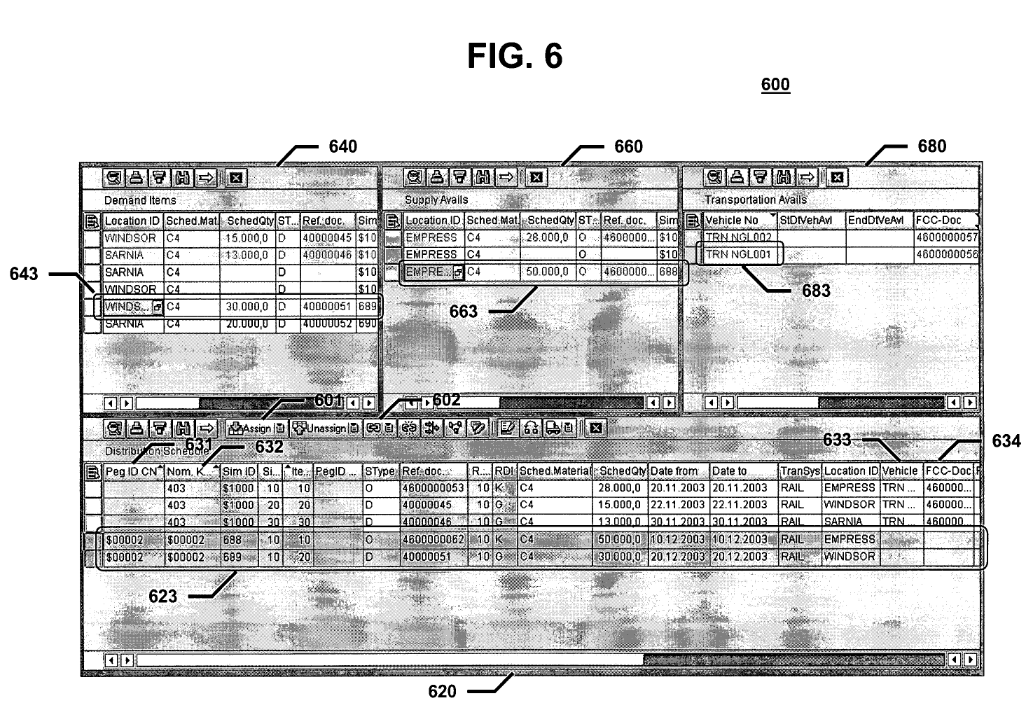

Referring to FIG. 6, distribution scheduling interface 600 may include, for example, distribution schedule window 620, demand window 640, supply window 660 and transportation window 680, similar to the embodiment depicted, generally, within FIG. 5. In one embodiment, a supply object and a demand object may be pegged to create a voyage. For example, demand item 643 specifies that 30,000 barrels of C4 material (e.g., light crude) is to be delivered to the WINDSOR location under contract reference “40000051,” as depicted in demand window 640. The scheduler may first select this demand item, and then review the available supply objects, depicted within supply window 660, to determine whether a single supply object includes a sufficient quantity of C4 material to fulfill the requirements of demand item 643. In this example, supply avail 663 specifies that 50,000 barrels of C4 material may be available at the EMPRESS location under contract reference “4600000062,” and, consequently, may fulfill the requirements of demand item 643.

Accordingly, supply avail 663 may be selected by the scheduler. In one embodiment, the scheduler may then review the available transportation objects, depicted within transportation window 680, to determine whether a transportation object may be capable of transporting the material. In another embodiment, the selected demand and supply objects may be pegged to a voyage first, and the quantities balanced, if desired, and then the transportation object may be selected and pegged to the existing voyage. The latter embodiment is discussed in further detail below.

Manual pegging icon 601 may be selected by the scheduler, and, in response, scheduling system 100 may peg, or assign, demand item 643 to supply avail 663 to create a voyage having an associated schedule object, depicted, for example, as voyage 623 within distribution schedule window 620. Scheduling system 100 may also create a simulated pegging identifier (e.g., “$00002”) and a simulated nomination key (e.g., “$00002”) for voyage 623, as depicted within the Peg ID CN 631 and Nom Key 632 columns of distribution schedule window 620. These identifiers may be amended during the subsequent nomination phase. Demand-supply pegging icon 602 may also be selected by the scheduler, and, in response, scheduling system 100 may peg demand item 643 to supply avail 663, within voyage 623, to represent loading, actualization, or other contractual requirements.

The schedule object may be stored within database 108. In an embodiment, scheduling system 100 may perform data checks to ensure consistency between the selected supply and demand objects (e.g., material type, available dates, etc.). For example, the transport system specified for each object may be checked to ensure that the demand location and the supply location have a common means of transportation (i.e., that it is physically possible to transport the supply material to the demand location). It may be noted that a transportation object has not yet been assigned to voyage 623, as indicated, for example, by the blank entries within the vehicle field of each row (e.g., vehicle identifier 633).

In some cases, the demand and supply quantities may be equal, in which case no additional quantity balancing would be required. However, and as presented within this example, the demand quantity and the supply quantity are not equal (i.e., 50,000 barrels supplied but only 30,000 barrels demanded). In one embodiment, one or more additional demand items may be assigned to voyage 623 to balance the total supply quantity. In another embodiment, voyage 623 may be completed as currently assigned, which may result in the delivery of 20,000 barrels of excess material to the demand location (i.e., WINDSOR), or the loss of scheduling availability for these 20,000 barrels of material at the supply location (i.e., EMPRESS). Unfortunately, either of these results may create inefficiencies within scheduling system 100.

In a further embodiment, supply avail 663 may be initially entered as a plurality of smaller supply objects, such as, for example, five supply objects each having a quantity of 10,000 barrels. In this embodiment, three of these supply objects may be selected to match the 30,000 barrel quantity specified by demand item 643. In yet another embodiment, scheduling system 100 may split supply avail 623 into two, or more, supply parcels, as required and at the appropriate time in the scheduling process. Of course, the total quantity split among the supply parcels remains the same as the original supply object, i.e., supply avail 663.

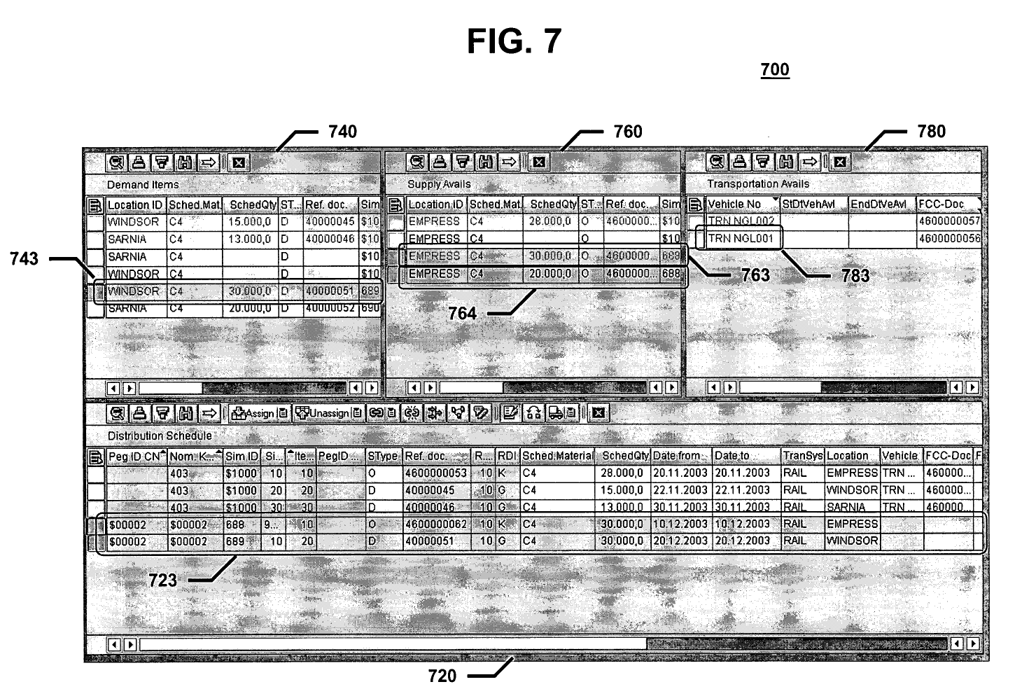

Referring to FIG. 7, distribution scheduling interface 700 may include, for example, distribution schedule window 720, demand window 740, supply window 760 and transportation window 780, similar to the embodiments depicted, generally, within FIGS. 5-6. In one embodiment, supply avail 663 may be split into supply avail 763 and supply avail 764 by entering the desired quantity into the quantity field of supply avail 663, such as, for example, entering 30,000 in place of 50,000 within supply window 660. Scheduling system 100 may recognize this entry as a request to split supply avail 663 into two supply parcels, resulting in supply avail 763 and supply avail 764 having quantities of 30,000 and 20,000 barrels, respectively, as depicted within supply window 760.

In one embodiment, supply avail 763 and supply avail 764 may be separate supply objects stored within database 108, while in another embodiment, supply avail 763 and supply avail 764 may represent a single supply object stored within database 108, in which the appropriate parcel information may be stored. After splitting supply avail 663 into supply avail 763 and supply avail 764, scheduling system 100 may then reflect the new quantity associated with supply avail 763, i.e., 30,000 barrels, within voyage 723. In one embodiment, the quantity associated with supply avail 763 may be considered to be a consumed portion, while the quantity associated with supply avail 764 may be considered to be an open portion. The quantities associated with supply avail 763 and demand item 743 are now equal, and the remaining 20,000 barrels may be available (i.e., “open”) for scheduling purposes once more (i.e., supply avail 764). Parcels may be re-combined as well, allowing the scheduler to easily reconstruct a previous pegging scenario.

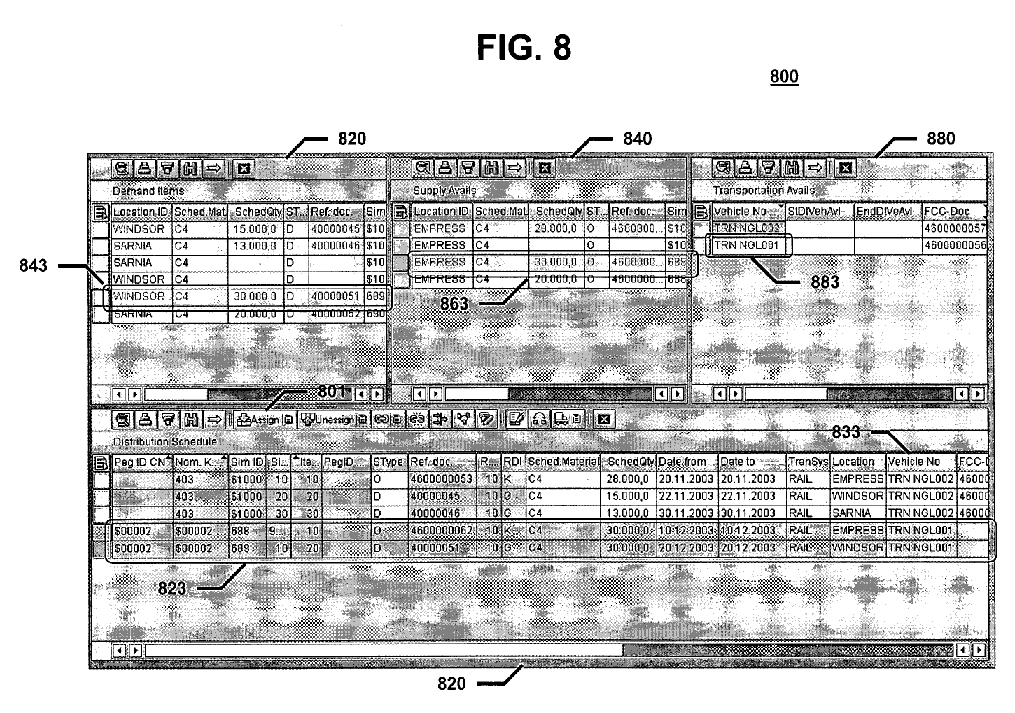

Referring to FIG. 8, distribution scheduling interface 800 may include, for example, distribution schedule window 820, demand window 840, supply window 860 and transportation window 880, similar to the embodiments depicted, generally, within FIGS. 5-7. In one embodiment, a transportation resource may now be assigned, although the transportation resource may have been assigned at the same time that the supply and demand resources were assigned, as noted above. For example, the scheduler may select voyage 823 within distribution schedule window 820, then select transport avail 883 within transportation window 880, and finally select the manual pegging icon 801 to peg, or assign, transportation avail 883 to voyage 823. In an embodiment, data checks may be performed by scheduling system 100 to ensure consistency with demand item 843 and supply avail 863. It may be noted that the vehicle number associated with transportation avail 863 is now indicated within the vehicle identifier field 833 of each row of voyage 823 (i.e., “TRN NGL001”). Of course, and as depicted within FIG. 8, multiple voyages may be included within a distribution schedule.

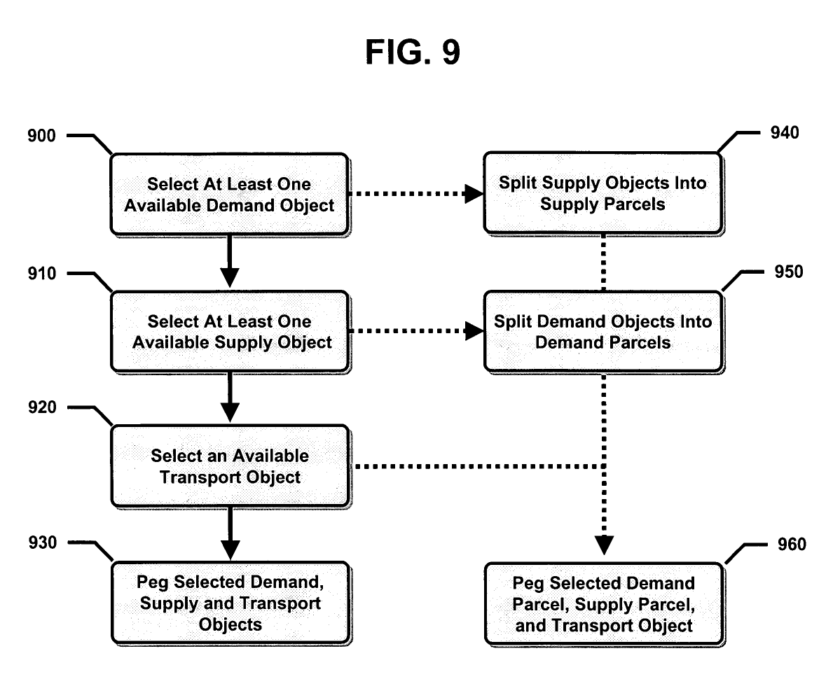

FIG. 9 is a top level flow diagram illustrating a method for creating a distribution schedule, according to an embodiment of the present invention.

Generally, and as discussed with reference to FIGS. 3-5, a plurality of demand, supply and transportation objects may be entered into database 108, from which a plurality of available demand, supply and transportation objects may be identified based upon a database search using availability criterion, such as dates, material types, locations, etc. The available demand, supply and transportation objects may then be presented to a user, or scheduler, using a graphical interface.

At least one demand object may be selected (900) from a plurality of available demand objects. With reference to the embodiment of FIG. 6, the scheduler may select (900) one or more demand objects, from the available demand objects presented within demand window 640 of distribution scheduling interface 600, to begin scheduling a voyage. For example, the scheduler may select (900) demand item 643, and then review the available supply objects presented within supply window 660 of distribution scheduling interface 600, to identify potential supply object candidates.

At least one supply object may be selected (910) from a plurality of available supply objects. Again, with reference to the embodiment of FIG. 6, the scheduler may select (910) one or more supply objects to match the various characteristics identified within the selected demand object, such as material type, quantity, etc. In this example, the scheduler may select (910) supply avail 663. Of course, demand and supply object selection may be transposed, so that the scheduler may begin by selecting one or more available supply objects and then reviews the available demand objects to identify potential demand object candidates. As discussed above, the selected demand and supply objects may be pegged prior to the selection, and subsequent pegging, of an available transportation object, or, an available transportation object may be selected prior to simultaneous pegging all three selected objects.

A transportation object may be selected (920) from a plurality of available transportation objects. With reference to the embodiment depicted in FIG. 8, the scheduler may select (920) a single transportation object to match the various characteristics identified within the selected demand and supply objects, such as material type, quantity, etc. In this example, the scheduler may select transport avail 683.

The selected supply object, the selected demand object and the selected transportation object may be pegged (930) to create a voyage having an associated distribution schedule object. In an embodiment, demand item 643, supply avail 663 and transport avail 683, selected by the scheduler, may be pegged (930) to create voyage 623. A distribution schedule object, associated with voyage 623, may be created and stored within database 108.

In a further embodiment, the selected supply object may be split (940) into a first supply parcel and a second supply parcel, and the selected demand object, the first supply parcel and the selected transportation object may be pegged (960) to create the voyage. With reference to the embodiments of FIGS. 6-7, demand item 643 may be selected (900) first and then supply avail 663 may be selected (910) next. However, because the quantity offered by supply avail 663 exceeds the quantity required by demand item 643 (i.e., 50,000 barrels versus 30,000 barrels), supply avail 643 may be split (940) into a first supply parcel 763, having a quantity equal to 30,000 barrels, and a second supply parcel 764, having a quantity equal to 20,000 barrels. The selected demand object (i.e., demand item 743), the first supply parcel (i.e., supply avail 763) and the selected transportation object 783 may then be pegged (960) to create voyage 623.

In similar manner, a selected demand object may be split (950) into a first demand parcel and a second demand parcel, and the first demand parcel, the selected supply object and the selected transportation object may be pegged (960) to create the voyage. In this embodiment, the supply object may be selected (910) first, and the demand object may be selected (900) second, so that the selected demand object may be split (950) into a first demand parcel and a second demand parcel. The selected supply object, the first demand parcel and the selected transportation object may then be pegged (960) to create the voyage. Of course, demand, supply and transportation objects may be split concurrently and pegged accordingly.

In another embodiment, the scheduler may select several available demand objects, several available supply objects and several available transportation objects and then select an automatic pegging function provided by scheduling system 100 to create several voyages automatically. In one embodiment, the automatic pegging function may use a ruleset to balance each of the selected demand, supply and transportation objects, matching quantities, materials, availability dates, etc., to create a plurality of balanced triplets (i.e., demand, supply and transportation objects). For example, the ruleset may prefer, or prioritize, demand objects, and may begin the balancing process by sorting the selected demand objects by quantity, for example, and then matching supply and transportation objects accordingly. Similarly, the ruleset may prefer, or prioritize, supply objects, and may begin the balancing process by sorting the selected supply objects by quantity, for example, and then matching demand and transportation objects accordingly. Transportation objects may also be preferred by the ruleset, in a similar fashion. In a further embodiment, the automatic pegging function may use a ruleset to balance only the selected demand and supply objects, matching quantities, materials, availability dates, etc., to create a plurality of balanced doublets (i.e., demand and supply objects). Manual pegging would then assign the balanced doublets to transportation objects.

Other balancing criterion may also be specified, including, for example, a balancing period horizon to limit availability dates, a balancing tolerance to avoid excessive iterations of smaller and smaller quantities (assuming balancing with splitting), a balancing accuracy to prevent solution non-convergence, which may include a processing duration to limit processor time spent on balancing, or a balancing percentage, etc. Once the plurality of balanced triplets have been created, the automatic pegging function then pegs each balanced triplet to create a plurality of voyages, storing the associated distribution schedule objects within database 108.

A simple automatic pegging ruleset for pegging demand objects and supply objects (without including transportation objects) may include several steps. Demand objects may be sorted in ascending date sequence in order to attempt to satisfy the most time-critical demands first. Supply objects may be similarly sorted to make sure open contract quantities available first are used first. Each demand object may be taken in turn through the following cycle: analyze open supply at top of current sorted supply list; check material match; check transportation system/route match; check data compatibility; determine lead time difference for transportation system/route; define latest possible supply date as demand request date; check that supply date (range) is available prior to, or equal to, requested supply date; assign/peg supply object to demand object; if supply quantity is greater than, or equal to, demand quantity, then cover 100% of demand with supply, and automatically split remaining supply as open quantity available for subsequent demands; if demand quantity is greater than supply quantity, then consume 100% of supply, and automatically split remaining demand as open quantity with requirement for further supply coverage; and continue until either all demands are covered, or all supplies are consumed, or remaining demands/supplies are non-compatible.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method for creating a distribution schedule, comprising:
selecting at least one demand object from a plurality of available demand objects;
selecting at least one supply object from a plurality of available supply objects;
selecting a transportation object from a plurality of available transportation objects; and
pegging the selected supply object, the selected demand object and the selected transportation object to create a voyage having an associated distribution schedule object.

2. The method of claim 1, further comprising:
pegging the selected demand object to the selected supply object.

3. The method of claim 1, further comprising:
splitting the selected supply object into a first supply parcel and a second supply parcel; and
pegging the first supply parcel, the selected demand object and the selected transportation object to create the voyage.

4. The method of claim 1, further comprising:
splitting the selected demand object into a first demand parcel and a second demand parcel; and
pegging the supply object, the first demand parcel and the selected transportation object to create the voyage.

5. The method of claim 1, further comprising:
populating a database with a plurality of supply objects, a plurality of demand objects and a plurality of transportation objects;
selecting at least one availability criterion;
searching the database, based on the availability criterion, to create the plurality of available supply objects, the plurality of available demand objects and the plurality of available transportation objects; and
presenting the plurality of available supply objects, the plurality of available demand objects and the plurality of available transportation objects to a user for selection.

6. The method of claim 1, wherein said pegging includes:
automatically balancing each selected supply object, each selected demand object and each selected transportation object to create a plurality of balanced triplets based on a ruleset; and
automatically pegging each balanced triplet to create a plurality of voyages, each having an associated distribution schedule object.

7. The method of claim 6, wherein the ruleset prioritizes demand objects.

8. The method of claim 6, wherein the ruleset prioritizes supply objects.

9. The method of claim 6, wherein the ruleset prioritizes transportation objects.

10. The method of claim 6, wherein the ruleset includes a balancing period horizon, a balancing accuracy and a balancing tolerance.

11. The method of claim 10, wherein the balancing accuracy includes at least one of a processing duration and a balance percentage.

12. The method of claim 1, wherein each available supply object, demand object and transportation object includes a date range, a type, a material, a quantity, and a location.

13. The method of claim 12, wherein the supply material, the demand material and the transportation material include at least one of a crude oil product, a refined oil product and a natural gas product.

14. The method of claim 13, wherein the supply type includes at least one of a refinery and a storage facility, the demand type includes at least one of a storage facility and a distribution facility and the transportation type includes at least one of a marine vessel, a train and a pipeline.

15. A computer readable medium including instructions adapted to be executed by a processor to perform a method for creating a distribution schedule, the method comprising:
selecting at least one demand object from a plurality of available demand objects;
selecting at least one supply object from a plurality of available supply objects;
selecting a transportation object from a plurality of available transportation objects; and
pegging the selected supply object, the selected demand object and the selected transportation object to create a voyage having an associated distribution schedule object.

16. The computer readable medium of claim 15, wherein the method further comprises:
pegging the selected demand object to the selected supply object.

17. The computer readable medium of claim 15; wherein the method further comprises:
splitting the selected supply object into a first supply parcel and a second supply parcel; and
pegging the first supply parcel, the selected demand object and the selected transportation object to create the voyage.

18. The computer readable medium of claim 15, wherein the method further comprises:
splitting the selected demand object into a first demand parcel and a second demand parcel; and
pegging the supply object, the first demand parcel and the selected transportation object to create the voyage.

19. The computer readable medium of claim 15, wherein the method further comprises:
populating a database with a plurality of supply objects, a plurality of demand objects and a plurality of transportation objects;
selecting at least one availability criterion;
searching the database, based on the availability criterion, to create the plurality of available supply objects, the plurality of available demand objects and the plurality of available transportation objects; and
presenting the plurality of available supply objects, the plurality of available demand objects and the plurality of available transportation objects to a user for selection.

20. The computer readable medium of claim 15, wherein said pegging includes:
automatically balancing each selected supply object, each selected demand object and each selected transportation object to create a plurality of balanced triplets based on a ruleset; and
automatically pegging each balanced triplet to create a plurality of voyages, each having an associated distribution schedule object.

21. The computer readable medium of claim 20, wherein the ruleset prioritizes demand objects.

22. The computer readable medium of claim 20, wherein the ruleset prioritizes supply objects.

23. The computer readable medium of claim 20, wherein the ruleset prioritizes transportation objects.

24. The computer readable medium of claim 20, wherein the ruleset includes a balancing period horizon, a balancing accuracy and a balancing tolerance.

25. The computer readable medium of claim 24, wherein the balancing accuracy includes at least one of a processing duration and a balance percentage.

26. The computer readable medium of claim 16, wherein each available supply object, demand object and transportation object includes a date range, a type, a material, a quantity, and a location.

27. The computer readable medium of claim 26, wherein the supply material, the demand material and the transportation material include at least one of a crude oil product, a refined oil product and a natural gas product.

28. The computer readable medium of claim 27, wherein the supply type includes at least one of a refinery and a storage facility, the demand type includes at least one of a storage facility and a distribution facility and the transportation type includes at least one of a marine vessel, a train and a pipeline.

29. A system for creating a distribution schedule, comprising:
a database including a plurality of supply objects, a plurality of demand objects and a plurality of transportation objects;
a processor coupled to the database; and
a memory, coupled to the processor, including instructions adapted to be executed by the processor to perform a method, the method comprising:
searching the database, based on an availability criterion, to create a plurality of available supply objects, a plurality of available demand objects and a plurality of available transportation objects,
selecting at least one demand object from the plurality of available demand objects,
selecting at least one supply object from the plurality of available supply objects,
selecting a transportation object from the plurality of available transportation objects, and
pegging the selected supply object, the selected demand object and the selected transportation object to create a voyage having an associated distribution schedule object.

30. The system of claim 29, wherein the method further comprises:
pegging the selected demand object to the selected supply object.

31. The system of claim 29, wherein the method further comprises:
splitting the selected supply object into a first supply parcel and a second supply parcel; and
pegging the first supply parcel, the selected demand object and the selected transportation object to create the voyage.

32. The computer readable medium of claim 29, wherein the method further comprises:
splitting the selected demand object into a first demand parcel and a second demand parcel; and
pegging the supply object, the first demand parcel and the selected transportation object to create the voyage.

33. The system of claim 29, wherein said pegging includes:
automatically balancing each selected supply object, each selected demand object and each selected transportation object to create a plurality of balanced triplets based on a ruleset; and
automatically pegging each balanced triplet to create a plurality of voyages, each having an associated distribution schedule object.

34. The system of claim 33, wherein the ruleset prioritizes at least one of demand objects, supply objects and transportation objects.

35. The system of claim 33, wherein the ruleset includes a balancing period horizon, a balancing accuracy and a balancing tolerance.

36. The system of claim 35, wherein the balancing accuracy includes at least one of a processing duration and a balance percentage.
